(19) United States
(12) Patent Application Publication
(10) Pub. No.: US 2006/0253864 A1
(43) Pub. Date: Nov. 9, 2006

(54) System and method for household-targeted advertising

(75) Inventor: Allen D. Easty, Plano, TX (US)

Correspondence Address: HAYNES AND BOONE, LLP, 901 MAIN STREET, SUITE 3100, DALLAS, TX, 75202, US

(73) Assignee: Optical Entertainment Network, Inc., Houston, TX (US)

(21) Appl. No.: 11/374,881

(22) Filed: Mar. 14, 2006

Related U.S. Application Data
(60) Provisional application No. 60/661,709, filed on Mar. 15, 2005.
(60) Provisional application No. 60/663,943, filed on Mar. 21, 2005.

(51) Int. Cl. H04N 7/173; H04N 5/445; H04N 7/10; G06F 13/00; G06F 3/00; H04N 7/025

(52) U.S. Cl. 725/35; 725/34; 725/46; 725/110; 725/112; 725/113

(57) ABSTRACT

A targeted television advertisement system comprises a customer premises equipment at a household and coupled to a television set, the customer premise equipment, which comprises a server operable to access a media storage device and demand-pull advertising elementary streams customized for a viewer of the household, and a splicer operable to receive a program elementary streams and splice the demand-pulled advertising elementary streams into the program elementary streams.

### RELATED PATENT APPLICATIONS

This patent application claims the benefit of U.S. Provisional Patent Application Nos. 60/661,709 and 60/663,943, filed on Mar. 15, 2005 and Mar. 21, 2005, respectively, both entitled System and Method for Household-Targeted Advertising and Online Trading of Television Advertising Space, which is incorporated herein by reference.

This patent application is related to co-pending U.S. Non-Provisional Patent Application entitled System And Method For Online Trading Of Television Advertising Space, (Attorney Docket No. 36054.8) filed on Mar. 14, 2006, which is incorporated herein by reference.

### BACKGROUND

Conventional broadcast television (TV) allowed local advertising to be inserted by local affiliate TV stations in nationally-broadcast programming. These advertising opportunities are called avails. Similarly, cable systems also offer avails for local advertising in the additional channels they carried. In both cases analog video switching is employed to insert the local advertising. A series of audio tones are used in the national feed to announce the upcoming avail for inserting the local advertisements.

With the transition to digital cable and digital satellite feeds, a digital system called Digital Program Insertion (DPI) was created to replace the audio cue tones and analog video switching. In both analog and digital systems, the advertisement is inserted in a central facility called a head-end, which serves all or a portion of a region such as a metropolitan area. All customers in that region watching the same channel will see the same local advertisement.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of an embodiment of a head-end system for digital advertising insertion;

FIG. 2 is a block diagram of an embodiment of video, data and control flow associated with a splicer and server; and

FIG. 3 is a block diagram of an embodiment of a system for household-targeted advertising on the new TV distribution networks; and

FIG. 4 is a flowchart of an embodiment of a method for household-targeted advertising on the new TV distribution networks.

### DETAILED DESCRIPTION

It is desirable to enable household-targeted advertising placement in TV broadcasting. Cable systems, including hybrid-fiber coax systems carrying digital video, are fundamentally centralized broadcast systems with the primary switching in the head-end. This is commonly referred to as topology limitation. Even cable providers that can provide some targeted video from the head-end in the form of video-on-demand (VOD) rely on a concept called over-subscription. Over-subscription implies that only a small number of customers, usually 10% or less, will actually request the TV cable service at the same time so the network can function without having the capacity to deliver the service to every TV in the system. Unfortunately, advertising avails tend to arrive at similar times across the range of channels so targeted advertising would require the ability to simultaneously target video to everyone watching a channel with a pending advertising avail. As no cable system has anywhere near this capacity (and the concept is impossible on satellite TV) no one in the cable or satellite community has specified commercially deployable systems for implementing household-targeted advertising.

A new kind of television distribution network called fiber-to-the-home (FTTH) is being deployed. Most FTTH networks simply carry the television as a digital cable feed and thus have the same limitations as a cable system. This method is called radio frequency (RF) insertion. However, a few FTTH providers are now carrying video-on-switched internet protocol (IP). On IP video—FTTH systems with enough capacity, specifically those with a 10/1Gbps point-to-point all fiber network, there is now appropriate topology and sufficient capacity to support targeted advertising.

The American National Standards Institute (ANSI) and the Society of Cable Television Engineers (SCTE) have jointly proposed the DPI standards in use today. The primary standards are ANSI/SCTE 35 Digital Program Insertion Cueing Message for Cable and ANSI/SCTE 30 Digital Program Insertion Splicing API. SCTE has also proposed working groups for advertising standards that include the word “targeted” but these efforts are for refinement of head-end based advertising systems that do not target individual households on cable. The SCTE standards also describe logical components called splicers and servers.

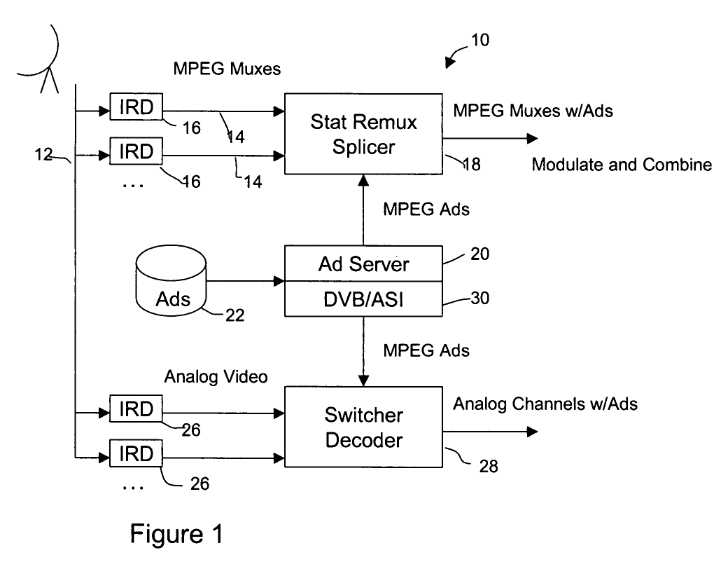

FIG. 1 is a block diagram of an embodiment of a head-end system 10 for digital advertising insertion. Digital satellite feeds 12 deliver groups of channels called muxes 14 to the head-end equipment. Embedded within these muxes 14 by content suppliers are the table entries that announce and describe the local ad avails. This information, which replaces the analog tone announcements, is specified by SCTE 35. Integrated receiver/decoders (IRDs) 16 receive and decode the muxes 14 and supply them to a splicer 18. An advertisement server 20 accesses advertisement stored in a database 22, digital video broadcast/asynchronous serial interface (DVB/ASI) 30 processes the received advertisement file, and then supplies them to splicer 18 to insert the advertisement pieces into the muxes. Server 20 and a splicer 18 perform the ad insertion by communicating with each other using the protocol defined by SCTE 30.

On the analog side, analog video are received and decoded by integrated receiver/decoders 26, which are coupled to a switcher decoder 28. Switcher decoder 28 receives the advertisement from advertisement server 20 and digital video broadcast/asynchronous serial interface (DVB/ASI) 30 and inserts the advertisements into the analog video feeds.

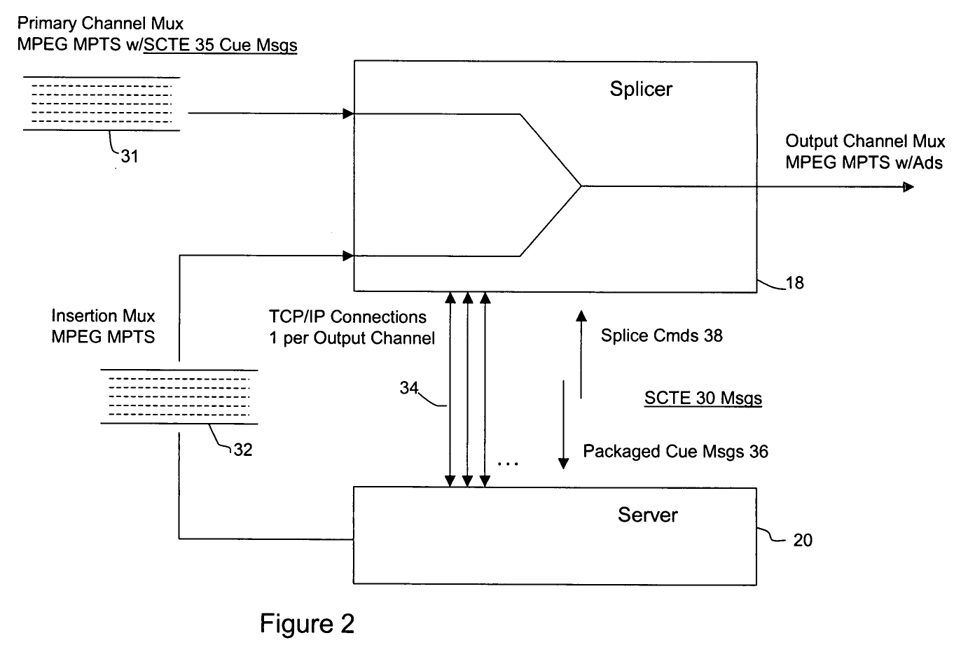

FIG. 2 is a block diagram of an embodiment of video, data and control flow associated with a splicer 18 and server 20. Note that a splicer 18 assumes multi-channel muxes for the primary channels (the programs into which ads will be inserted) 31 and the insertion channels (the ads themselves) 32. The muxes are preferably MPEG multiple program transport streams (MPTS) on serial digital video connections (in DVB/ASI format). A series of TCP/IP connections 34, one per output channel (a primary channel that supports avails with ads inserted), carry the SCTE 30 protocol messages between server 20 and splicer 18. SCTE 30 messages 36 are primarily repackaged (and possibly time-adjusted) SCTE 35 cueing messages 36 sent from splicer 18 to server 20 and splice execution commands 38 sent from server 20 to splicer 18. Note that components and protocols are uniquely suited to the multi-channel muxes that flow through the head-end. The ad storage 22 (FIG. 1) may be an adjunct to server 20.

Three kinds of video splicing are proposed by the standards. Transport stream splicers are designed for video where the splice points occur that the packet boundaries of the entire channel mux—the transport stream packets. This arrangement is not supported by satellite feeds to cable head-ends and is not generally implemented for DPI. Elementary stream splicers operate on the presentation unit (video/audio frame generally) boundaries of the elementary streams. Elementary streams are the individual video, audio, and data streams that are part of each program (channel) in the multi-channel mux. Thus the elementary stream splicer de-multiplexes both the primary channel and insertion channel muxes, splice the elementary streams, and re-multiplex the result into the output channel mux. Partial re-encode splicers are elementary stream splicers where some of the presentation units are partially de-coded and re-encoded, usually by a method called re-quantization, to manipulate the bit rate of the resulting stream. This technique is generally employed by splicers that are embedded in statistical re-multiplexers that support rate shaping to produce a consistent and optimized output channel mux of a given total rate. Full re-encode splicers completely decode channel and insertion streams into pictures, splice the pictures together, and re-encode the result. This is usually a prohibitively expensive operation. The most common splicers are elementary stream and partial re-encode splicers.

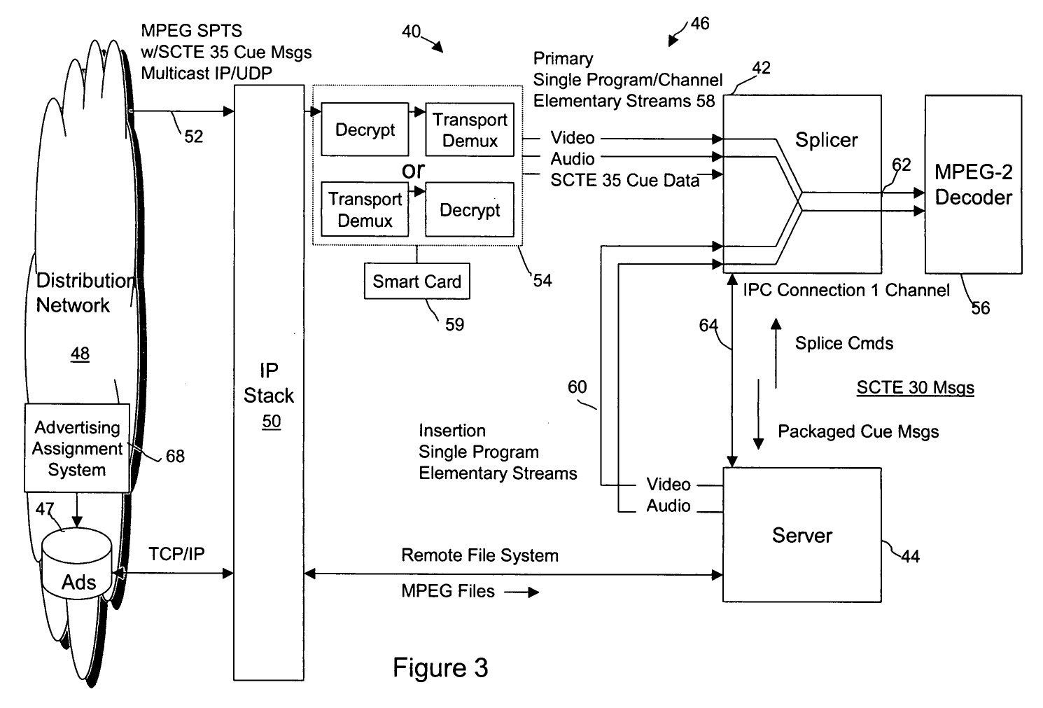

FIG. 3 is a block diagram of an embodiment of a system 40 and method for household-targeted advertising on the new TV distribution networks. System 40 comprises a splicer 42 and a server 44 in the consumer premises equipment, generally but not limited to a set-top box 46 connected to a TV. System 40 further includes an ad storage 47 out of the head-end, generally but not limited to, distribution facilities in a network 48. Distribution network 48 is generally, but is not limited to, a Fiber-To-The-Home (FTTH) network including metropolitan facilities, distribution links, neighborhood facilities and the fiber links to households. Other networks with similar or more advanced capabilities may also be used.

An IP (Internet Protocol) Stack 50 resides in set-top box 46 and processes all IP incoming and outgoing traffic, including both video and data. In this example, the video arrives at set-top box 46 as an MPEG single program transport stream (MPEG SPTS) on multicast IP 52. The MPEG SPTS 52 also contains the SCTE 35 cueing messages in a table structure that announce and describe the local ad avails. These messages are passed through the IP head-end to set-top box 46.

The video in the single program transport stream 52 arriving at set-top box 46 may have the original advertising content blanked by a process in the IP head-end. A standard head-end DPI system may be used for this process as long as the SCTE 35 cueing messages are not removed by the DPI system.

Splicer 42 resides between a MPEG decryption/de-multiplexing module/function 54 and a MPEG decoder 56. Most cable set-top boxes combine these functions on a single chip. Fortunately set-top boxes for IP video provide support for separating these components.

Decryption/de-multiplexing module 54 resides on set-top box 46 and converts the encrypted MPEG SPTS into unencrypted elementary streams 58. The SPTS is either decrypted and de-multiplexed or de-multiplexed and decrypted depending on the solution provided by a smart card 59. The unwrapping of the transport stream is still called de-multiplexing even when only a single program (channel) is enclosed. The result is the elementary streams 58, which comprise video and audio streams of a single program or channel and the SCTE 35 cueing as a data element stream.

Splicer 42 inserts advertising in set-top box 46. Splicer 42 processes only a single program's elementary streams and a single ad's elementary streams 60. Splicer 42 may be implemented as a software component on set-top box 46 or a hardware component in the head-end. The splicer is an elementary stream splicer. Partial re-encode isn't necessary as the program is already in the set-top box. The spliced element streams 62 are not re-multiplexed but are passed directly to MPEG decoder 56, which then passes the spliced video and audio streams to a television set.

Server 44 also resides in the set-top box and supplies elementary streams of single program of advertising 60 to splicer 42. The server may be implemented as software or as a hardware component. The server may use inter-process communication (IPC) to deliver a single program of advertising elementary streams 60 to splicer 42 and for the single control channel 64 over which SCTE 30 messages are sent.

Advertising storage 47 may be a file system server or servers within distribution network 48. The ads themselves are accessed by server 44 in set-top box 46 via a protocol including but not limited to HTTP or remote file system from the physical file system in the distribution network, generally a server in the facility housing the neighborhood distribution network equipment. The server on the set-top box demand-pulls and buffers the MPEG ad files over reserved bandwidth, allowing the in-network ad file servers to be “dumb” and inexpensive.

The advertising file to be inserted in the specific time slot to the specific household is determined by an advertising assignment system 68. System 68 determines which ad should be inserted based on information including, but not limited to, what ads have already been inserted and viewed in the household and how many times; the demographics of the household; the previous activity of the customer on the system including channels watched, impulse product purchases and electronic commerce purchases; external market research information; and advertising purchasing and trading systems.

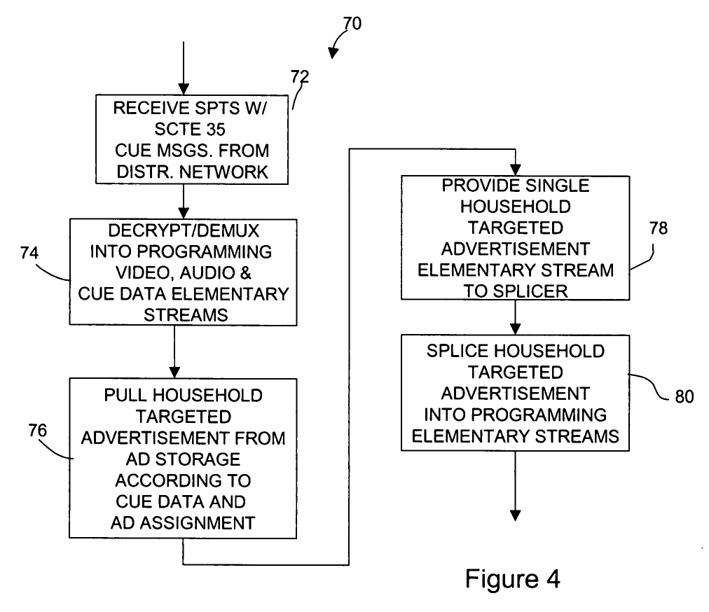

FIG. 4 is a flowchart of an embodiment of a method 70 for household-targeted advertising on the new TV distribution networks. Referring also to FIG. 3, in step 72, SPTS with SCTE 35 cue messages are received from distribution network 48 by IP stack 50. In step 74, the received data is decrypted and then demultiplexed or demultiplexed and then decrypted to yield the single programming video, audio and cue data elementary streams 58. In step 76, specific ads are pull-demanded or otherwise requested by server 44 from ad storage 47. The timing of the ad avails are indicated by the cue data. The ads are specified by advertising assignment system 68 and are tailored to the household at which the programming is being shown. In step 78, the ad stream is provided to splicer 42. In step 80, the ad stream is then spliced or inserted into the programming elementary streams. The resultant video and audio streams are then provided to a television set or otherwise displayed to the household audience.

According to the system and method described above, by using a set-top box as part of customer premises equipment, the advertising for each household may be customized and tailored according to a number of criteria such as demographics, income level, personal interests, ads already seen, favorite TV channels, and other settings. The set-top box receives information in the video streams about the channels and times where ad avails exist. When an ad avail is signaled (usually a few seconds before the actual avail), an ad specifically chosen for this household and time is pulled from network storage to the set-top box and spliced into the video stream for forwarding to the TV set. When the ad is completed, the viewer is returned to the original video stream. It does matter which television channel the household is viewing, the targeted ads can be inserted into the avails of any program.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A targeted television advertisement system comprising:
a customer premises equipment at a household and coupled to a television set, the customer premise equipment comprising:
a server operable to access a media storage device and demand-pull advertising elementary streams customized for a viewer of the household; and
a splicer operable to receive a program elementary streams and splice the demand-pulled advertising elementary streams into the program elementary streams.

2. The system of claim 1, wherein the customer premises equipment further comprises an IP stack coupled to a programming distribution network and operable to receive a single program transport stream.

3. The system of claim 2, wherein the customer premises equipment further comprises a decryption/demultiplexing module operable to process the single program transport stream and generate program elementary streams therefrom.

4. The system of claim 3, wherein the program elementary streams comprise video streams, audio streams, and cue data streams.

5. The system of claim 4, wherein the cue data streams comprise SCTE 35 cue data.

6. The system of claim 1, wherein the customer premises equipment further comprises a MPEG decoder coupled to the splicer.

7. A targeted advertising device co-located with a television set of a household, comprising:
an IP stack coupled to a programming distribution network and operable to receive a single program transport stream;
a decryption/demultiplexing module operable to process the single program transport stream and generate program elementary streams therefrom;
a server operable to request an advertising file targeted at the household; and
a splicer coupled to the server and operable to splice the targeted advertising file into the program elementary streams.

8. The system of claim 7, wherein the program elementary streams comprise video streams, audio streams, and cue data streams.

9. The system of claim 8, wherein the cue data streams comprise SCTE 35 cue data.

10. The system of claim 7, wherein the customer premises equipment further comprises a MPEG decoder coupled to the splicer.

11. The system of claim 7, further comprising an advertising assignment module operable to select an advertising file targeted at the household according to a set of predetermined criteria.

12. The system of claim 11, wherein the advertising assignment module is operable to select the advertising file according to at least one of demographics, income, and personal interests.

13. A method for household-targeted advertising, comprising:
receiving a single program transport stream from a distribution network;
decrypting and demultiplexing the single program transport stream and generating single programming elementary streams;
accessing a data storage device for an ad file tailored to a household; and
splicing into the programming elementary streams the ad file.

14. The method of claim 13, wherein generating single programming elementary streams comprises generating video streams, audio streams, and cue data streams.

15. The method of claim 14, wherein generating cue data streams comprises generating SCTE 35 cue data.

16. The method of claim 13, wherein receiving the single program transport stream comprises receiving a multicast IP/UDP.

17. The method of claim 13, wherein accessing a data storage comprises receiving TCP/IP ad data.

18. The method of claim 13, further comprising selecting an advertisement best suited to the household according to a set of predetermined criteria.

19. The method of claim 13, further comprising selecting an advertisement best suited to the household according to at least one of income, demographics, personal interests and personal preferences.
